(19) United States
(12) Patent Application Publication
(10) Pub. No.: US 2019/0384128 A1
(43) Pub. Date: Dec. 19, 2019

(54) COLOR FILM SUBSTRATE, MANUFACTURING METHOD THEREOF AND DISPLAY DEVICE

(71) Applicant: WUHAN CHINA STAR OPTOELECTRONICS TECHNOLOGY CO., LTD., Wuhan, Hubei (CN)

(72) Inventors: GUANGHUI HONG, Shenzhen (CN); QIANG GONG, Shenzhen (CN)

(21) Appl. No.: 15/576,193

(22) PCT Filed: Oct. 21, 2017
(86) PCT No.: PCT/CN2017/107173

§ 371 Date: Sep. 28, 2018

(30) Foreign Application Priority Data
Sep. 26, 2017 (CN) 201710927242.9

(51) Int. Cl. G02F 1/1362; G02F 1/1335

(52) U.S. Cl. CPC G02F 1/136209; G02F 1/136204; G02F 1/133514

(57) ABSTRACT

A color film substrate, a manufacturing method thereof and a display device are provided, which relates to the field of display technology. The color film substrate includes a substrate, on which a display area and a non-display area are defined, wherein the non-display area is arranged at the peripheral of the display area; a first shading layer with a first conductivity arranged on the non-display area; and a second shading layer with a second conductivity arranged on one side of the non-display area that is away from the display area, wherein the second shading layer is arranged at the peripheral of the first shading layer and surrounds the first shading layer, the second conductivity is less than the first conductivity. In this way, the problem that the color film substrate is damaged by the static electricity could be solved, thereby improving the anti-static electricity ability of the color film substrate.

### CROSS-REFERENCE TO RELATED APPLICATIONS

The present application is a 35 U.S.C. § 371 National Phase conversion of International (PCT) Patent Application No. PCT/CN2017/107173 filed Oct. 21, 2017, which claims foreign priority of Chinese Patent Application No. 201710927242.9, filed on Sep. 26, 2017 in the State Intellectual Property Office of China, the contents of all of which are hereby incorporated by reference.

### TECHNICAL FIELD

Embodiments of the present disclosure generally relate to display technology, and in particular relate to a color film substrate, a manufacturing method thereof and a display device.

### BACKGROUND

The existing display panel and display device including the display panel are often affected by static electricity during producing, manufacturing and transmitting, resulting in that the display panel cannot work normally, even that the display panel is so badly damaged that it cannot light when the static electricity value reaches a certain level.

### SUMMARY

The technical problem that the present disclosure mainly solves is to provide a color film substrate, a manufacturing method thereof and a display device, which could improve the anti-static electricity ability of the display panel, and solve the problem that the display panel cannot work normally because of the affecting of the static electricity.

In order to resolve the technical problem mentioned above, a technical scheme adopted by the present disclosure is to provide a color film substrate, including a substrate defining a display area and a non-display area arranged at a peripheral of the display area; a first shading layer with a first conductivity arranged on the non-display area; and a second shading layer with a second conductivity arranged on one side of the non-display area that is away from the display area, wherein the second shading layer is arranged at a peripheral of the first shading layer and surrounds the first shading layer, the second conductivity is less than the first conductivity.

In order to resolve the technical problem mentioned above, another technical scheme adopted by the present disclosure is to provide a manufacturing method of a color film substrate, including providing a substrate, wherein a display area and a non-display area are defined on the substrate, the non-display area is arranged at a peripheral of the display area; forming a first shading layer with a first conductivity on the non-display area; and forming a second shading layer with a second conductivity on a same layer as the first shading layer, wherein the second shading layer is arranged at a peripheral of the first shading layer and surrounds the first shading layer, the second conductivity is less than the first conductivity.

In order to resolve the technical problem mentioned above, another technical scheme adopted by the present disclosure is to provide a display device including a color film substrate, wherein the color film substrate includes a substrate, on which a display area and a non-display area are defined, wherein the non-display area is arranged at the peripheral of the display area; a first shading layer with a first conductivity arranged on the non-display area; and a second shading layer with a second conductivity arranged on one side of the non-display area that is away from the display area, wherein the second shading layer is arranged at a peripheral of the first shading layer and surrounds the first shading layer, the second conductivity is less than the first conductivity.

Compared with the prior art, the present disclosure provides a color film substrate, a manufacturing method thereof and a display device, wherein the color film substrate includes a substrate, on which a display area and a non-display area are defined, wherein the non-display area is arranged at a peripheral of the display area; a first shading layer with a first conductivity arranged on the non-display area; and a second shading layer with a second conductivity arranged on one side of the non-display area that is away from the display area, wherein the second shading layer is arranged at a peripheral of the first shading layer and surrounds the first shading layer, the second conductivity is less than the first conductivity. Therefore in the color film substrate of the present disclosure, the second shading layer with a smaller conductivity is disposed at the outer side of the first light shading layer on the non-display area, which may make it more difficult for the static electricity to pass through the non-display area, thereby protecting the color film substrate from being damaged by the static electricity.

### BRIEF DESCRIPTION OF THE DRAWINGS

In order to illustrate the technical solution in the embodiments of the present disclosure more clearly, the accompanying drawings to be used in the description of the embodiments are briefly described below. It will be apparent that the accompanying drawings in the following description are merely embodiments of the present disclosure, other accompanying drawings may be obtained without creative work for those skilled in the art.

FIG. 1 is a schematic diagram of a color film substrate according to an embodiment of the present disclosure.

FIG. 2 is a cross-sectional view of the color film substrate taken along a line of II-II′ shown in FIG. 1 according to an embodiment of the present disclosure.

FIG. 3 is an enlarged view of region III of the color film substrate shown in FIG. 1 according to an embodiment of the present disclosure.

FIG. 4 is an enlarged view of region III of the color film substrate shown in FIG. 1 according to another embodiment of the present disclosure.

FIG. 5 is a cross-sectional view of the color film substrate taken along a line of II-II′ shown in FIG. 1 according to another embodiment of the present disclosure.

FIG. 6 is a flow chart diagram of a manufacturing method of the color film substrate according to an embodiment of the present disclosure.

FIG. 7 is a schematic diagram of a display device according to an embodiment of the present disclosure.

FIG. 8 is a cross-sectional view of the display device taken along a line of VI-VI′ shown in FIG. 7.

### DETAILED DESCRIPTION

In order to make the technical problem, the technical solution and the technical effect described in the embodiments of the present disclosure more clearly and definitely, the technical solution of the present disclosure will be described in detail in connection with the drawings and embodiments.

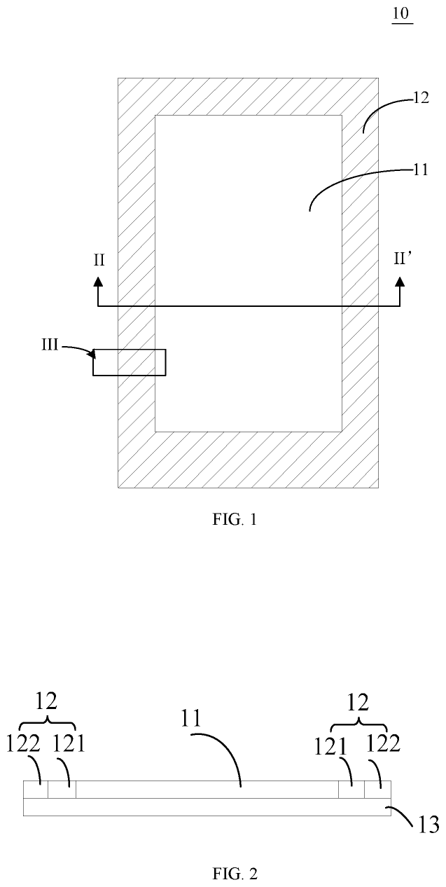

Referring to FIGS. 1 to 2, a schematic diagram of a color film substrate according to an embodiment of the present disclosure and a cross-sectional view of the color film substrate taken along a line of II-II′ shown in FIG. 1 according to an embodiment of the present disclosure are depicted. The color film substrate 10 may include a base 13, the base 13 may include a display area 11 and a non-display area 12, and the non-display area 12 may be arranged at a periphery of the display area 11. A first shading layer 121 and a second shading layer 122 may be arranged on the non-display area 12. The first shading layer 121 may surround the display area 11, and the second shading layer 122 may be arranged at periphery of the first shading layer 121 and surround the first shading layer 121. The first shading layer 121 has a first conductivity, while the second shading layer 122 has a second conductivity, wherein the second conductivity is less than the first conductivity.

Therefore, in the color film substrate 10 of the present disclosure, the second shading layer 122 with a smaller conductivity is disposed at the outer side of the first light shading layer 121 on the non-display area 12, which may make it more difficult for the static electricity to pass through the non-display area 12, thereby protecting the color film substrate 10 from being damaged by the static electricity.

The color film substrate 10 may be a CF (Color Filter) substrate of an LCD (liquid crystal display) panel. The first shading layer 121 and the second shading layer 122 may be prepared via mask developing process, which may include: providing a substrate; etching the first shading layer 121 on one side of the substrate via a first mask developing process; etching the second shading layer 122 via a second mask developing process, the first shading layer 121 and the second shading layer 122 may be arranged on a same layer in order to reduce the thickness of the color film substrate 10. The specific manufacturing steps will be illustrated below, the details are not recited herein.

In this embodiment, the first shading layer 121 may be made of material the same as a BM (Black Matrix) layer of the color film substrate 10, such as metal oxide film and resin, etc., the BM layer may be used for separating the display area into individual pixels. The BM layer may be formed on the color film substrate 10 via the mask developing process. The first shading layer 121 made of material the same as the BM layer could be formed simultaneously with the BM layer. When forming the BM layer, the first shading layer 121 could be formed at the same time by adjusting the mask. In this way, the manufacturing process could be simpler and the production could be more convenient.

It can be understood that in other embodiments, the material of the first shading layer 121 may be different from that of the BM layer. That is, the material of the first shielding layer 121 could be selected according to actual requirement.

The second shading layer 122 may be made of color photoresist, the color photoresist may include at least one of the red (R), green (G) and blue (B) photoresists. In this embodiment, the display area 11 and non-display area 12 may be arranged on one side of the base 13, and the non-display area 12 may be arranged at the periphery of the display area 11. The first shading layer 121 and the second shading layer 122 may be arranged on the non-display area 12. The first shading layer 121 may surround the display area 11, and the second shading layer 122 may be disposed at the periphery of the first shading layer 121 and surround the first shading layer 121. The second shading layer 122 may be a monochromatic photoresist layer, for example, the second shading layer 122 may be formed by one of the red (R), green (G) and blue (B) photoresists, the conductivity of the first shading layer 121 is greater than that of the second shading layer 122. The material of the second shading layer 122 has conductivity less than that of the first shading layer 121, which could shield the external static electricity and prevent the external static electricity from damaging the color film substrate 10.

In other embodiments, the second shading layer 122 may be formed by multiple photoresists with different colors. For instance, in one embodiment, the second shading layer 122 may be alternately arranged by multiple photoresists on a same layer, in another embodiment, the second shading layer 122 may be alternately stacked by different photoresist layers.

In the embodiment that the second shading layer 122 is alternately arranged by multiple photoresists on a same layer, the second shading layer 122 may be alternately arranged by banded photoresist layers with different colors, or interlaced by banded photoresist layers with different colors.

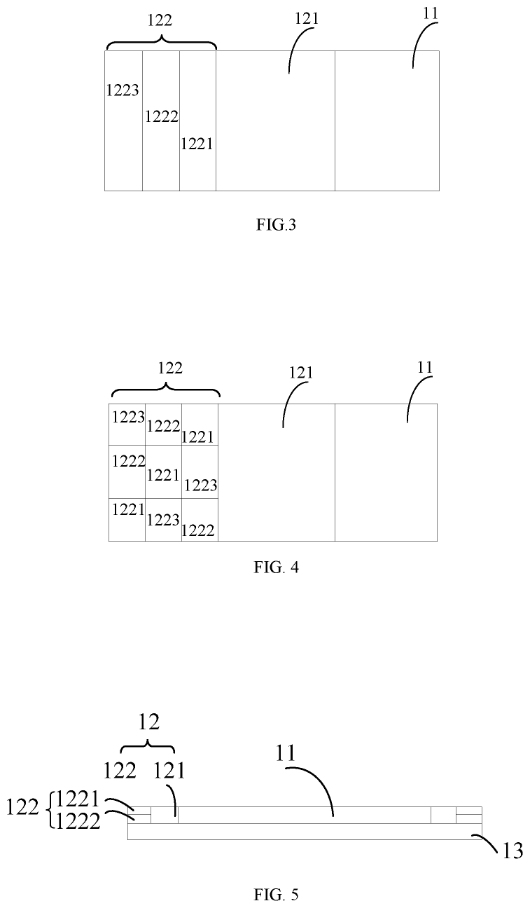

Referring to FIG. 3, a cross-sectional view of the color film substrate taken along a line of II-II′ shown in FIG. 1 according to an embodiment of the present disclosure is depicted. In this embodiment, the second shading layer 122 may be alternately arranged by a red photoresist layer 1221, a green photoresist layer 1222 and a blue photoresist layer 1223 that has a band shape respectively. The conductivity of the second shading layer 122 may be reduced by the alternate arrangement of the banded photoresist layers, which could make antistatic performance better. In this embodiment, the banded photoresist layers may be in an order of: the red photoresist layer 1221, the green photoresist layer 1222 and the blue photoresist layer 1223 in the direction of gradually away from the first shading layer 121, which could be abbreviated as an arrangement of RGB. In another embodiment, the order of the banded photoresist layers may be the red photoresist layer 1221, the blue photoresist layer 1223 and the green photoresist layer 1222, which could be abbreviated as an arrangement of RBG. And so on, in other embodiments, the banded photoresist layers could be in an arrangement of GRB, GBR, BGR or BRG. Furthermore, the second shading layer 122 may be alternately arranged by two banded photoresist layers in an arrangement of RG, RB, GR, GB, BR or BG.

Moreover, referring to FIG. 4, the second shading layer 122 may be interlaced and stitched by the red photoresist layer 1221, the green photoresist layer 1222 and the blue photoresist layer 1223.

Referring to FIG. 5, a cross-sectional view of the color film substrate taken along a line of II-II′ shown in FIG. 1 according to another embodiment is depicted. This embodiment shows that the second shading layer 122 is alternately stacked by different photoresist layers. In this embodiment, the second shading layer 122 may be alternately stacked by two color photoresist layers with different colors. The second shading layer 122 may include the red photoresist layer 1221 and the green photoresist layer 1222. The green photoresist layer 1222 may be arranged on one surface of the base 13, the red photoresist layer 1221 may be arranged on one surface of the green photoresist layer 1222 that is away from the base 13. The thickness of the red photoresist layer 1221 and the green photoresist layer 1222 is equal to that of the first shading layer 121. The two color photoresist layers in this embodiment may be the red photoresist layer 1221 and the green photoresist layer 1222, while in other embodiments, the two color photoresist layers may also be any two of the red, green and blue photoresist layers. In the direction away from the surface of the base 13, the red photoresist layer 1221 and the green photoresist layer 1222 may be in an arrangement of RG, RB, GR, GB, BR or BG. Furthermore, the second shading layer 122 may further include three different color photoresist layers. For example, the red photoresist layer 1221, the green photoresist layer 1222 and the blue photoresist layer 1223 may alternately stack to form the second shading layer 122, wherein the blue photoresist layer 1223 is arranged on one surface of the red photoresist layer 1221 that is away from the green photoresist layer 1222. The thickness of the red photoresist layer 1221, the green photoresist layer 1222 and the blue photoresist layer 1223 is equal to that of the first shading layer 121. In other embodiments, the red photoresist layer 1221, the green photoresist layer 1222 and the blue photoresist layer 1223 may be in an arrangement of RGB, RBG, GRB, BGR or BRG.

In this embodiment, the second shading layer 122 is arranged at the peripheral of the first shading layer 121 and surrounds the first shading layer 121. In other embodiments, a BM layer could be arranged at the peripheral of the second shading layer 122 to protect the second shading layer 122.

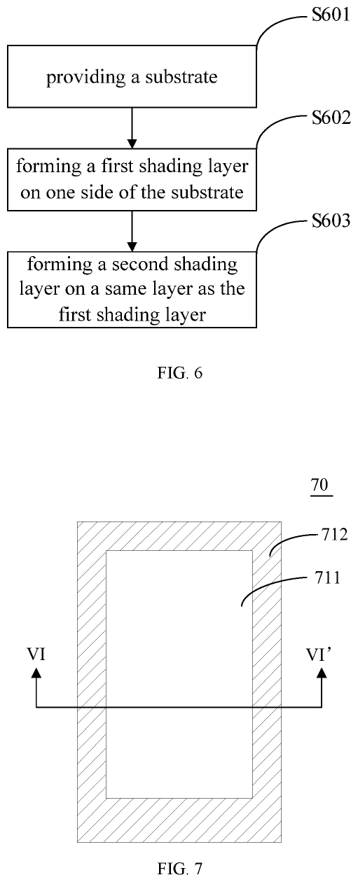

Please referring to FIG. 6, a flow chart diagram of a manufacturing method of the color film substrate according to an embodiment of the present disclosure is depicted. The manufacturing method of the color film substrate may include: providing a substrate, forming a first shading layer on one side of the substrate and forming a second shading layer on a same layer as the first shading layer. Particularly, the manufacturing method of the color film substrate may include the following blocks:

S601: providing a substrate having a display area and a non-display area defined thereon, wherein the non-display area may be at the peripheral of the display area.

The substrate may be a glass substrate, the glass substrate may be treated as follows:

a, cleaning the glass substrate.

b, etching the cleaned glass substrate to obtain an etched glass substrate of which the thickness is greater than that is required for the substrate.

c, rubbing down the etched glass substrate to reach the required smoothness and thickness.

S602: forming a first shading layer with a first conductivity on the non-display area.

The first shading layer is formed on one side of the substrate via mask developing process, which may include the following blocks:

a, cleaning the substrate.

b, coating a photoresist layer used for forming a BM layer on one side of the cleaned substrate.

c, centrifugating the substrate having a photoresist layer thereon to make the thickness of the photoresist layer uniform.

d, treating the substrate with a mask, and etching the photoresist layer on the substrate to form a BM layer.

When treating the substrate with the mask, the first shading layer could be formed at the peripheral of the BM layer by adjusting the structure of the mask.

e, cleaning the substrate after the BM layer is formed to obtain a substrate having the first shading layer arranged thereon.

Optionally, the first shading layer and the BM layer may be formed separately. When forming the first shading layer, material with a conductivity less than that of the BM layer could be selected, which could improve the anti-static electricity ability of the first shading layer, thereby improving the anti-static electricity ability of the color film substrate.

S603: arranging a second shading layer with a second conductivity on a same layer as the first shading layer, the second shading layer is arranged at the peripheral of the first shading layer and surrounds the first shading layer, wherein the second conductivity is less than the first conductivity.

A second mask developing process may be used to treat the substrate having the first shading layer thereon to form the second shading layer at the peripheral of the first shading layer.

The second shading layer may have conductivity less than that of the first shading layer. The second shading layer may be made of photoresists, such as RGB photoresists.

Optionally, when the second shading layer is made of monochromatic photoresist, the monochromatic photoresist could be coated at the peripheral of the first shading layer by the manner of coating. When the second shading layer is alternately arranged by different banded photoresist layers or interlaced by multiple banded photoresist layers with different colors, multiple mask developing processes may be needed to form the required second shading layer.

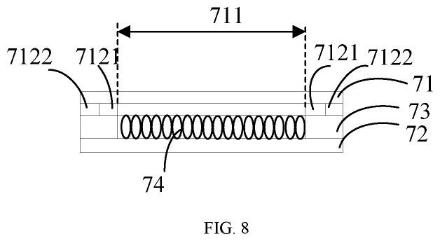

Please referring to FIGS. 7 to 8, a schematic diagram of the structure of a display device according to an embodiment of the present disclosure and a cross-sectional view of the display device taken along a line of VI-VI′ shown in FIG. 7 are depicted. The display device 70 of this embodiment may include a color film substrate 71, an array substrate 72, a rubber frame 73 and a liquid crystal layer 74. The liquid crystal layer 74 may be arranged in a sealed space defined by the rubber frame 73, the color film substrate 71 and the array substrate 72. The color film substrate 71 may include a display area 711 and a non-display area 712. The non-display area 712 may include a first shading layer 7121 and a second shading layer 7122. The second shading layer 7122 may be made of at least one of color photoresist layers and the conductivity of the second shading layer 7122 is less than that of the first shading layer 7121. The structure of the second shading layer 7122 and the arrangement of the at least one of color photoresist layers are illustrated above, the details are not recited herein.

The second shading layer 7122 may be arranged at the non-display area of the CF substrate. The second shading layer made of color photoresist is arranged on the non-display area of the CF substrate of the present disclosure, which could prevent the external static electricity from entering into the display device through the color film substrate, thereby improving the anti-static electricity ability of the display device. Furthermore, in order to improve the anti-static electricity ability of the whole display device, the non-display area of the array substrate may also have a second shading layer arranged thereon.

Therefore, the second shading layer with small conductivity is added to the edge of the display device, which could prevent the external static electricity from entering into the display device, thereby improving the anti-static electricity ability of the display device and improving the performance of display device.

In conclusion, the anti-static electricity ability of the color film substrate and the display device of the present disclosure are improved, thereby improving the performance of the display device.

The above description depicts merely some exemplary embodiments of the disclosure, but is meant to limit the scope of the disclosure. Any equivalent structure or flow transformations made to the disclosure, or any direct or indirect applications of the disclosure on other related fields, shall all be covered within the protection of the disclosure.

1. A color film substrate, comprising:
a substrate, on which a display area and a non-display area are defined, wherein the non-display area is arranged at the peripheral of the display area;
a first shading layer with a first conductivity arranged on the non-display area; and
a second shading layer with a second conductivity arranged on one side of the non-display area that is away from the display area, wherein the second shading layer is arranged at the peripheral of the first shading layer and surrounds the first shading layer, the second conductivity is less than the first conductivity.

2. The color film substrate according to claim 1, wherein the first shading layer is a black matrix shading layer, while the second shading layer is a color photoresist layer.

3. The color film substrate according to claim 2, wherein the second shading layer is a monochromatic photoresist layer.

4. The color film substrate according to claim 2, wherein the second shading layer is stitched by multiple color photoresist layers with different colors.

5. The color film substrate according to claim 4, wherein the multiple color photoresist layers are alternately arranged or interlaced by multiple banded photoresist layers with different colors.

6. A manufacturing method of a color film substrate, comprising:
providing a substrate, wherein a display area and a non-display area are defined on the substrate, the non-display area is arranged at the peripheral of the display area;
forming a first shading layer with a first conductivity on the non-display area; and
forming a second shading layer with a second conductivity on a same layer as the first shading layer, wherein the second shading layer is arranged at the peripheral of the first shading layer and surrounds the first shading layer, the second conductivity is less than the first conductivity.

7. The manufacturing method according to claim 6, wherein the first shading layer is a black matrix shading layer, while the second shading layer is a color photoresist layer.

8. The manufacturing method according to claim 7, wherein the second shading layer is stitched by multiple color photoresist layers with different colors.

9. The manufacturing method according to claim 8, wherein the multiple color photoresist layers with different colors are alternately arranged or interlaced by multiple banded photoresist layers with different colors.

10. A display device, comprising a color film substrate, wherein the color film substrate comprises:
a substrate, on which a display area and a non-display area are defined, wherein the non-display area is arranged at the peripheral of the display area;
a first shading layer with a first conductivity arranged on the non-display area; and
a second shading layer with a second conductivity arranged on one side of the non-display area that is away from the display area, wherein the second shading layer is arranged at the peripheral of the first shading layer and surrounds the first shading layer, the second conductivity is less than the first conductivity.

11. The display device according to claim 10, wherein the first shading layer is a black matrix shading layer, while the second shading layer is a color photoresist layer.

12. The display device according to claim 11, wherein the second shading layer is a monochromatic photoresist layer.

13. The display device according to claim 11, wherein the second shading layer is stitched by multiple color photoresist layers with different colors.

14. The display device according to claim 13, wherein the multiple color photoresist layers are alternately arranged or interlaced by multiple banded photoresist layers with different colors.

15. The color film substrate according to claim 2, wherein the second shading layer is alternately stacked by different photoresist layers.

16. The manufacturing method according to claim 7, wherein the second shading layer is a monochromatic photoresist layer.

17. The manufacturing method according to claim 7, wherein the second shading layer is alternately stacked by different photoresist layers.

18. The display device according to claim 11, wherein the second shading layer is alternately stacked by different photoresist layers.
